(19) United States
(12) Patent Application Publication
(10) Pub. No.: US 2003/0209387 A1
(43) Pub. Date: Nov. 13, 2003

(54) Ladder accessory

(76) Inventor: Robert Henry Burr, Wilmington, NC (US)

Correspondence Address: James E Brunton Esquire, Post Office Box 29000, Glendal, CA, 91209-9000, US

(21) Appl. No.: 10/141,253

(22) Filed: May 8, 2002

(51) Int. Cl. E06C 5/32

(52) U.S. Cl. 182/129

(57) ABSTRACT

Ladder Accessory with a first clamp assembly capable of removably retaining a support pole, a second clamp assembly capable of attaching to the leg of a ladder, the first and second clamp assemblies being connected by a retaining screw, the first clamp having a block containing a bisected cylindrical cutout. A locking knob that draws the two halves of the cylindrical cutout together thereby retaining the pole. The second clamp has a plurality of opposed gripping fingers. Threaded thumb screws allow the second clamp to be fastened to the leg of a standard ladder. An open topped container has integral side walls and a base plate. A pole retaining socket on the underside of the base plate retains the support pole.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of ladders and more specifically to a ladder Accessory.

Ladders for use in reaching areas above normal hand reach, have been in existence for thousands of years. In recent times ladders are frequently used for such chores as painting a house or other building, replacing light bulbs, contruction projects and the like.

Modern ladders often include a shelf member that folds out near the top rung of the ladder. This shelf is meant for resting items that are being used for a particular activity. For example, a paint can, a portable drill, a power stapler and the like. Unfortunatly, items placed on such a shelf may slip off if the ladder is moved. Additionally, the shelf is frequently in the wrong position for ideal access during a particular activity. Finally, existing ladder shelves can not be moved to other positions depending on the nature of the job to be done.

### BRIEF SUMMARY OF THE INVENTION

The primary object of the invention is to provide a ladder accessory that holds items that are frequently used when using a ladder.

Another object of the invention is to provide a ladder accessory that makes using ladders safer and easier.

Another object of the invention is to provide a ladder accessory that is easy to adjust and assemble.

A further object of the invention is to provide a ladder accessory that attaches to most types and sizes of ladders.

Yet another object of the invention is to provide a ladder accessory that clamps securely to a ladder.

Still yet another object of the invention is to provide a ladder accessory that holds a gallon sized paint can.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Ladder Accessory comprising: a first clamp assembly capable of removably retaining a pole, a second clamp assembly capable of attaching to the leg of a ladder, said first and second clamp assemblies being connected by a retaining screw, the communicating surface between said first and second clamp assemblies having a mating radial pattern so that said first clamp assembly can be rotated with respect to said second clamp assembly and then locked together, said first clamp having a block containing a bisected cylindrical cutout, said cutout capable of retaining a support pole, said first clamp having a locking knob that draws the two halves of said cylindrical cutout together thereby retaining said support pole, said first clamp having a resilient sleeve that slips over said support pole and within the inside diameter of said cylindrical cutout, said second clamp having a plurality of opposed gripping fingers, one set of said fingers having threaded thumb screws that communicate with clamping bars so that said second clamp can be fastened to the leg of a standard ladder, an open topped container having integral side walls and base plate capable of retaining items such as a can of paint, cleaning materials or the like, said container having a pole retaining socket on the underside of said base plate that retains said support pole, and said container having a plurality of side wall cutouts capable of letting the handle of a brush or the like extend from said open topped container.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the present invention mounted to a ladder

FIG. 2 is a perspective view of the clamping assembly

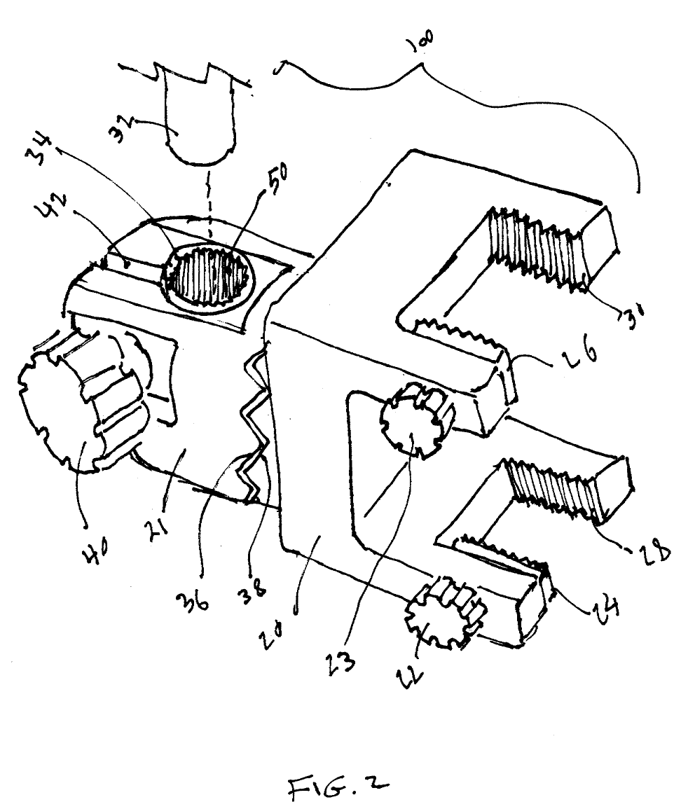

FIG. 3 is a left end view of the clamping assembly

FIG. 4 is a right end view of the clamping assembly

FIG. 5 is a side view of the clamping assembly

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

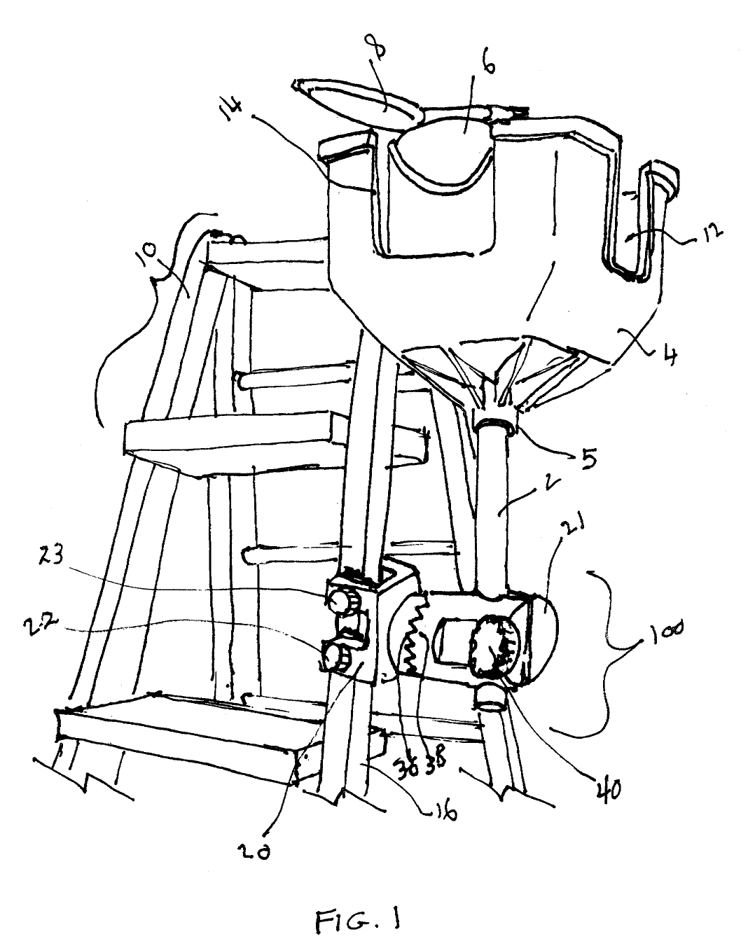

Referring now to FIG. 1 we see a perspective view of the present invention as it is clamped to the leg of a standard ladder 10. A clamping assembly 100 consists of two main parts 20, 21 and attaches on one side to a standard ladder leg 16, and on the opposite side to a support pole 2. Knob 40 can be loosened and tightened to allow support pole 40 to be raised or lowered and then locked in position. Knobs 22, 23 allow clamping part 20 to be attached to a ladder leg at any desired location. Radial locking gear teeth 36, 38 allow clamp part 21 to be rotated and locked so that pole 2 can be set in a vertical position with relation to the ground. Open topped container 4 is attached to pole to at the underside of the base of the container 2 at junction point 5. The interior dimensions of the container 4 are large enough to receive a one gallon paint can 6. Cutouts 12, 14 in container 4 allow items, such as brush handle 6 to extend beyond the container 4 walls.

FIG. two shows a perspective view of the clamping assembly 100. Knobs 22, 23 can be turned to cause clamping bars 24, 26 to impinge on a ladder leg thereby forcing the ladder leg between clamping bars 24, 26 and opposing clamp fingers 28, 30. The split 42 in clamping part 21 allows the part 21 to compress when knob 40 is turned thereby causing support tube 32 to be gripped firmly. Sleeve 50 is made of resilient material such as rubber to further aid in the gripping process.

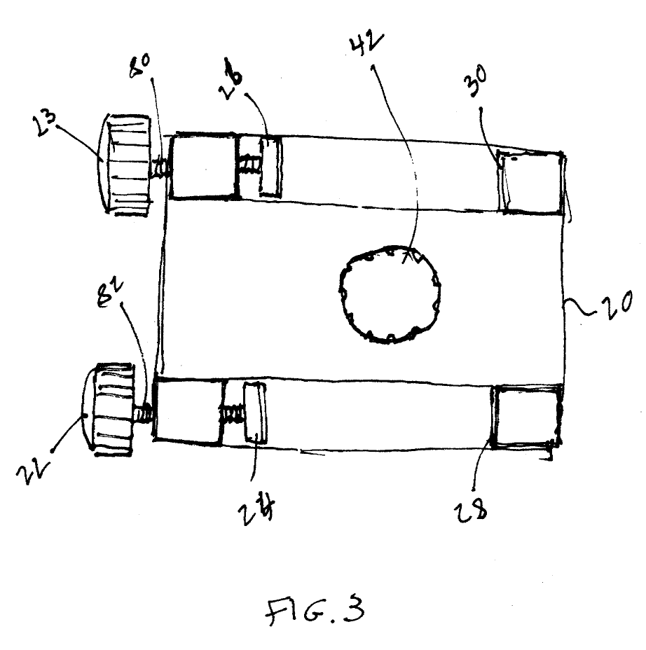

FIG. 3 is a end view of clamping part 20 that shows knob 42 that is used to tighten or loosen radial teeth 36, 38 thereby allowing a rotational adjustment of part 20. Tightening knobs 22, 23 are also clearly shown in relation to screws 80, 82 and the screw's connection to clamping bars 24, 26.

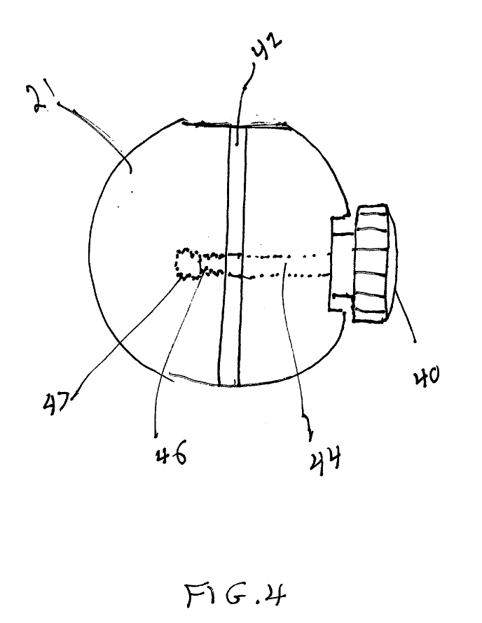

FIG. 4 shows an end view of clamping member 21 where slit 42 is clearly seen. Threaded portion 46 communicates with female threads 47 so that slit 42 is reduced when knob 40 is tightened.

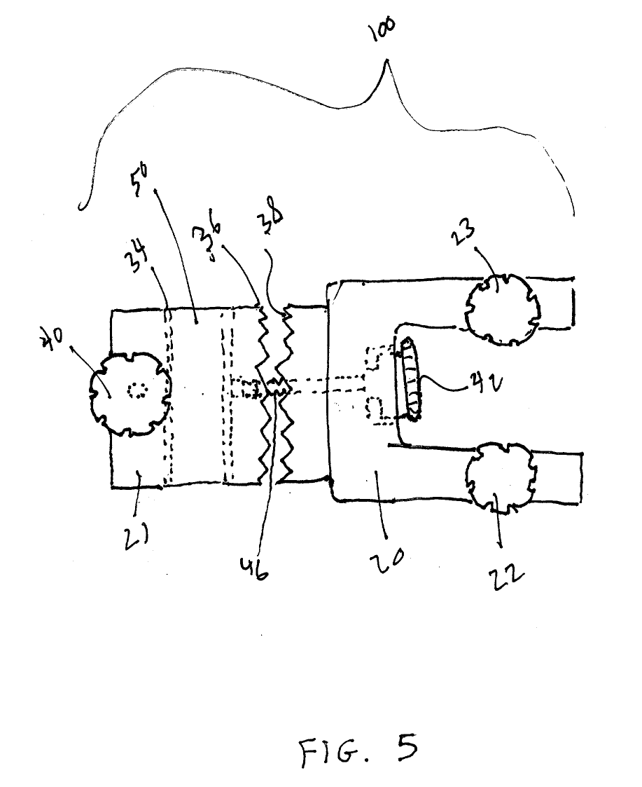

FIG. 5 is a top view of the clamping assembly 100. Locking teeth 36, 38 are shown in the open position that allows the user to rotate clamp member 20. Knob 42 is then screwed tight to cause the teeth to mesh and lock. Split cylindrical aperture 50 can be seen and resilient sleeve 34 can also be seen.

In the above described and illustrated way, the present invention helps a person to safely place useful items in close proximity to the task being performed while performing those tasks while standing on a ladder.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Ladder Accessory comprising:
a first clamp assembly capable of removably retaining a pole;
a second clamp assembly capable of attaching to the leg of a ladder;
said first and second clamp assemblies being connected by a retaining screw;
the communicating surface between said first and second clamp assemblies having a mating radial pattern so that said first clamp assembly can be rotated with respect to said second clamp assembly and then locked together;
said first clamp having a block containing a bisected cylindrical cutout,
said cutout capable of retaining a support pole;
said first clamp having a locking knob that draws the two halves of said cylindrical cutout together thereby retaining said light pole;
said first clamp having a resilient sleeve that slips over said support pole and within the inside diameter of said cylindrical cutout;
said second clamp having a plurality of opposed gripping fingers;
one set of said fingers having threaded thumb screws that communicate with clamping bars so that said second clamp can be fastened to the leg of a standard ladder;
an open topped container having integral side walls and base plate capable of retaining items such as a can of paint, cleaning materials or the like;
said container having a pole retaining socket on the underside of said base plate that retains said support pole; and
said container having a plurality of side wall cutouts capable of letting the handle of a brush or the like extend from said open topped container.

2. Ladder Accessory as claimed in claim 1 wherein said accessory is injection molded from rigid plastic

3. Ladder Accessory as claimed in claim 1 wherein said support pole can be raised or lowered and then locked in place.

4. Ladder Accessory as claimed in claim 1 wherein said second clamp assembly can be rotated and locked with respect to said first clamp assembly so that even though the leg of a standard ladder is at an angle, said support pole can be set to be vertical.
